(19) United States
(12) Patent Application Publication
(10) Pub. No.: US 2026/0003206 A1
(43) Pub. Date: Jan. 1, 2026

(54) FLOATING IMAGE DISPLAY APPARATUS AND METHOD OF MANUFACTURING PRISM FILM FOR THE FLOATING IMAGE DISPLAY APPARATUS

(71) Applicant: SAMSUNG ELECTRONICS CO., LTD., Suwon-si (KR)

(72) Inventors: Kihyung KANG, Suwon-si (KR); Sanghyun SOHN, Suwon-si (KR)

(73) Assignee: SAMSUNG ELECTRONICS CO., LTD., Suwon-si (KR)

(21) Appl. No.: 19/283,754

(22) Filed: Jul. 29, 2025

Related U.S. Application Data
(63) Continuation of application No. PCT/KR2025/007368, filed on May 29, 2025.

(30) Foreign Application Priority Data
Jun. 26, 2024 (KR) 10-2024-0084039

(51) Int. Cl. G02B 30/56; G02B 30/60

(52) U.S. Cl. CPC G02B 30/56; G02B 30/60

(57) ABSTRACT

A floating image display apparatus includes: a display configured to output light corresponding to an image; and a prism film configured to reflect the light output by the display into a floating image, where the prism film comprises a plurality of prism strips stacked in a first direction, and where at least one prism strip among the plurality of prism strips comprises: a substrate layer extending in a second direction perpendicular to the first direction, and a plurality of prisms provided along the second direction on a first surface of the substrate layer.

### CROSS-REFERENCE TO RELATED APPLICATION(S)

This application is a continuation of International Application No. PCT/KR2025/007368, filed on May 29, 2025, in the Korean Intellectual Property Receiving Office, which is based on and claims priority to Korean Patent Application No. 10-2024-0084039, filed on Jun. 26, 2024, in the Korean Intellectual Property Office, the disclosures of which are incorporated by reference herein in their entireties.

### BACKGROUND

### 1. Field

The disclosure relates to a floating image display apparatus and prism film, an optical member used for the floating image display apparatus.

### 2. Description of Related Art

The floating image display apparatus is a display device for displaying images in mid-air (aerial images). The floating image display apparatus may use the principle of retro-reflection or a dihedral corner reflector array (DCRA) to form a floating image.

The DCRA reflects light containing an original image twice, forming a real floating image on the opposite side of the original image. The floating image may be formed at a location as far from the DCRA as a distance from the original image to the DCRA.

The DCRA may be formed by alternately piling secondary mirror structures composed of thin glass plates aligned parallel to each other on primary mirror structures composed of thin glass plates aligned parallel to each other. This method, however, requires cutting, aligning and stacking thin glasses, making the process difficult and costly.

### SUMMARY

Provided is a floating image display apparatus using a prism film to reflect light.

Further, provided is a method of manufacturing the prism film for the floating image display apparatus.

Additional aspects will be set forth in part in the description which follows and, in part, will be apparent from the description, or may be learned by practice of the presented embodiments

According to an aspect of the disclosure, a floating image display apparatus may include: a display configured to output light corresponding to an image; and a prism film configured to reflect the light output by the display into a floating image, where the prism film comprises a plurality of prism strips stacked in a first direction, and where at least one prism strip among the plurality of prism strips comprises: a substrate layer extending in a second direction perpendicular to the first direction, and a plurality of prisms provided along the second direction on a first surface of the substrate layer.

At least one prism among the plurality of prisms may have a shape of a triangular prism.

The at least one prism may include: a first base having a shape of a right-angled triangle; a second base having a shape corresponding to the first base; a first lateral face having a shape of a rectangle; a second lateral face having a shape corresponding to the first lateral face and forming a right angle with the first lateral face; and a diagonal face connecting the first lateral face and the second lateral face.

The diagonal face may be facing the first surface of the substrate layer.

The at least one prism may be configured to receive the light output by the display through the first base, reflect the light with the first lateral face and the second lateral face in sequence, and emit the light through the second base.

The at least one prism may be configured to provide the floating image based on the light emitted through the second base.

The plurality of prisms may include a light-transparent material having a higher refractive index than air.

The plurality of prism strips may include an adhesive layer on a second surface of the substrate layer, the second surface being opposite to the first surface.

The prism film may include a filler layer between the plurality of prism strips.

A refractive index of the filler layer may be lower than a refractive index of the plurality of prisms.

The filler layer may have a black color.

Among the plurality of prism strips, a first prism strip and a second prism strip stacked on the first prism strip may be arranged to correspond along the second direction.

Among the plurality of prism strips, a first prism strip and a second prism strip stacked on the first prism strip may be arranged to be offset along the second direction.

According to an aspect of the disclosure, a prism film may include: a plurality of substrate layers stacked in a first direction; a plurality of prisms having a shape of a triangular prism and provided along the second direction on a first surface of each of the plurality of substrate layers, where the plurality of prisms are configured to reflect light output by a display into a floating image.

The plurality of prisms respectively comprise: a first base having a shape of a right-angled triangle; a second base having a shape corresponding to the first base; a first lateral face having a shape of a rectangle; a second lateral face having a shape corresponding to the first lateral face and forming a right angle with the first lateral face; and a diagonal face connecting the first lateral face and the second lateral face.

The plurality of prisms may be configured to receive the light output by the display through the first base, reflect the light with the first lateral face and the second lateral face in sequence, and emit the light through the second base into the floating image.

The prism film may further include a filler layer between the plurality of prisms and the plurality of substrate layers, where the filler layer has a black color, and where a refractive index of the filler layer is lower than a refractive index of the plurality of prisms.

Among the plurality of substrate layers, a first substrate layer is stacked on a second substrate layer, and a plurality of prisms provided on the first substrate layer may be arranged to correspond with a plurality of a plurality of prisms provided on the second substrate layer along the second direction.

Among the plurality of substrate layers, a first substrate layer is stacked on a second substrate layer, where a plurality of prisms provided on the first substrate layer may be arranged to be offset with a plurality of a plurality of prisms provided on the second substrate layer along the second direction.

According to an aspect of the disclosure, a method of manufacturing a prism film for a floating image display apparatus may include: preparing a plurality of prism sheets, each of the plurality of prism sheets including a plurality of prisms arranged in a first direction; stacking the plurality of prism sheets in a second direction perpendicular to the first direction to form a stacked prism structure; and cutting the stacked prism structure along a cutting plane.

The cutting plane may extend in the second direction perpendicular to the first and second directions.

The preparing of the plurality of prism sheets may include preparing a substrate layer; and forming the plurality of prisms on a surface of the substrate layer.

The method may further include forming an adhesive layer on a second surface of the substrate layer.

The method may further include filling a filler layer between the plurality of prism sheets.

Each of the plurality of prisms may extend in a third direction perpendicular to the first and second directions.

The plurality of prisms may each have the shape of a triangular prism.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates an operation of a floating image display apparatus, according to an embodiment of the disclosure;

FIG. 2 is an enlarged view of portion ‘O’ of a prism film of FIG. 1, according to an embodiment of the disclosure;

FIG. 3 illustrates a prism and a path of light entering the prism, according to an embodiment of the disclosure;

FIG. 4 is a side view of the prism of FIG. 3, according to an embodiment of the disclosure;

FIG. 5 is a plan view of the prism of FIG. 3, according to an embodiment of the disclosure;

FIG. 6 illustrates a path of light entering a prism film, according to an embodiment of the disclosure;

FIG. 7 is a side view of the path of light of FIG. 6, according to an embodiment of the disclosure;

FIG. 8 illustrates a method of manufacturing a prism film for a floating image display apparatus, according to an embodiment of the disclosure;

FIG. 9 illustrates a prism sheet, according to an embodiment of the disclosure;

FIG. 10 illustrates a prism stacked structure, according to an embodiment of the disclosure;

FIG. 11 is a plan view illustrating an operation of cutting the prism stacked structure of FIG. 10, according to an embodiment of the disclosure;

FIG. 12 illustrates a prism film formed by the operation of cutting the prism stacked structure of FIG. 11, according to an embodiment of the disclosure;

FIG. 13 illustrates a prism stacked structure, according to an embodiment of the disclosure;

FIG. 14 illustrates a prism film formed by cutting the prism stacked structure of FIG. 13, according to an embodiment of the disclosure;

FIG. 15 illustrates a prism stacked structure, according to an embodiment of the disclosure; and

FIG. 16 illustrates a prism film formed by cutting the prism stacked structure of FIG. 15, according to an embodiment of the disclosure.

### DETAILED DESCRIPTION

It is understood that various embodiments of the disclosure and associated terms are not intended to limit technical features herein to particular embodiments, but encompass various changes, equivalents, or substitutions.

Like reference numerals may be used for like or related elements throughout the drawings.

The singular form of a noun corresponding to an item may include one or more items unless the context states otherwise.

In the disclosure, “A or B”, “at least one of A and B”, “at least one of A or B”, “A, B or C”, “at least one of A, B and C”, and “at least one of A, B, or C” may each include any one or all the possible combinations of A, B and C.

The expression “and/or” is interpreted to include a combination of any one or more of associated elements.

Terms like “first”, “second”, etc., may be simply used to distinguish an element from another, without limiting the elements in a certain sense (e.g., in terms of importance or order).

The terms ‘front’, ‘rear’, ‘top’, ‘bottom’, ‘side’, ‘left’, ‘right’, ‘upper’, ‘lower’, etc., as herein used are defined with respect to the drawings, but the terms may not restrict the shape and position of the respective components.

It will be further understood that the terms “include”, “includes”, “has”, “having”, “comprise” and “comprising,” when used in the disclosure, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

Reference will now be made in detail to embodiments of the disclosure with reference to accompanying drawings.

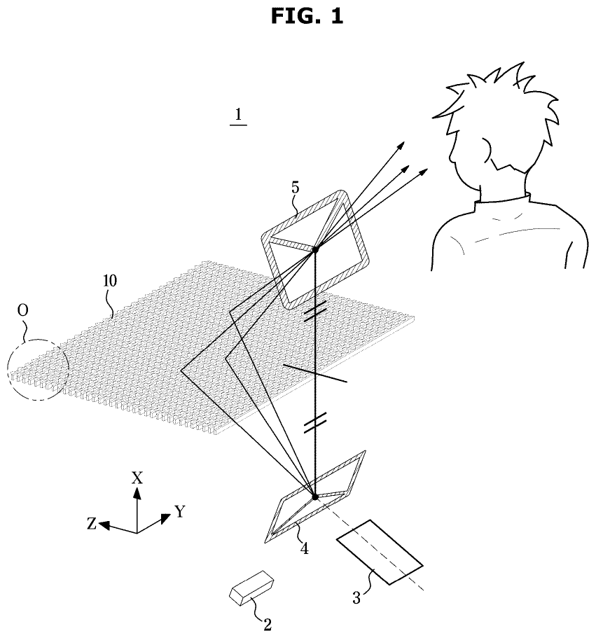

FIG. 1 illustrates operation of a floating image display apparatus, according to an embodiment of the disclosure.

A floating image display apparatus 1 is a display device that forms an aerial floating image 5. The floating image display apparatus 1 may include an image former 3 (e.g., a display) that forms an original image 4, and a prism film 10, 20 or 30 that forms a floating image 5 by reflecting light provided from the image former 3.

The image former 3 may provide light that forms the original image 4. The original image 4 is not limited to a particular type, and may be, for example, a two-dimensional (2D) or three-dimensional (3D) image. The image former 3 may be a display device for outputting an image or an actual object. For example, the image former 3 may include a liquid crystal display (LCD) device, an organic light emitting diode (OLED) display device, a micro LED, a quantum dot (QD) LED, but is not limited thereto. In an embodiment in which the display device equipped in the image former 3 is a non-luminous device such as an LCD, the image former 3 may further include a light source to provide light for image formation.

The original image 4 is shown in the drawings conceptually to describe propagation of light that contains the original image 4, and may correspond to an image displayed on a display plane of the image former 3.

The light provided from the image former 3 and entering the prism film 10, 20 or 30 may be reflected in the prism film 10, 20 or 30 and then emitted to the outside of the prism film 10, 20 or 30. For example, light entering the prism film 10, 20, or 30 may be totally reflected multiple times, and then emitted to the outside of the prism film 10, 20 or 30. From a different perspective, the light provided from the image former 3 may be transmitted through the prism film 10, 20 or 30. As shown in FIG. 1, the light provided from the image former 3 may be transmitted through the prism film 10 in the direction X.

The floating image 5 is a real image that is created when beams provided from the image former 3 are reflected by the prism film 10, 20 or 30 and actually gathered. In other words, the floating image 5 is a real image of the original image 4 formed of the beams provided from the image former 3 formed in mid-air.

The floating image 5 may have a planar symmetry relationship with respect to the original image 4 and the prism film 10. Accordingly, the distance between the floating image 5 and the prism film 10 may be equal to the distance between the original image 4 and the prism film 10. The larger the size of the prism film 10, the larger distance and viewing angle between the floating image 5 and the prism film 10 may be secured.

The floating image display apparatus 1 may further include a sensor 2 for recognizing a touch, a gesture, etc., of the user in the aerial area where the floating image 5 is located. The sensor 2 may include various types of sensors such as one or more of a position sensor, an acceleration sensor, a 3D sensor, a proximity sensor, an infrared (IR) sensor, a biometric sensor, but is not limited thereto.

The user may control the floating image display apparatus 1 for an operation of touching the aerial area where the floating image 5 is located, and contactless interaction between the user and the aerial display device 1 may be enabled.

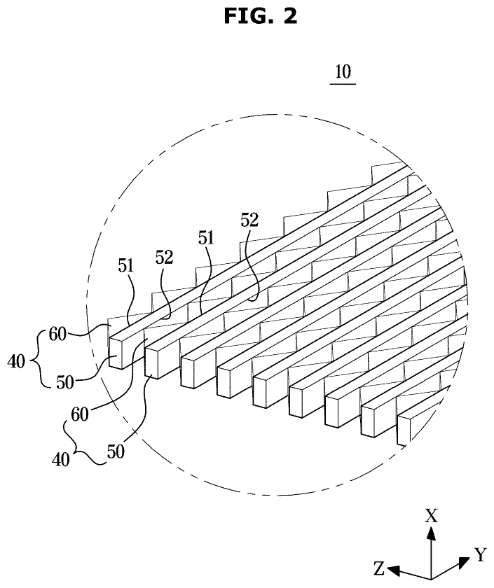

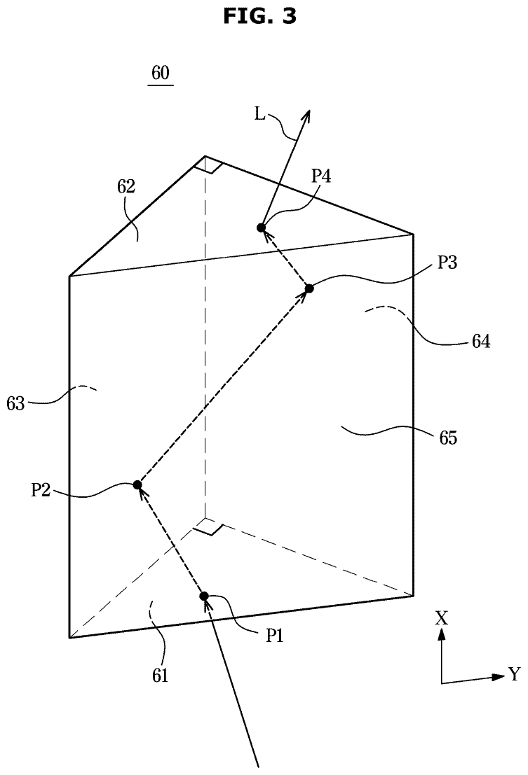

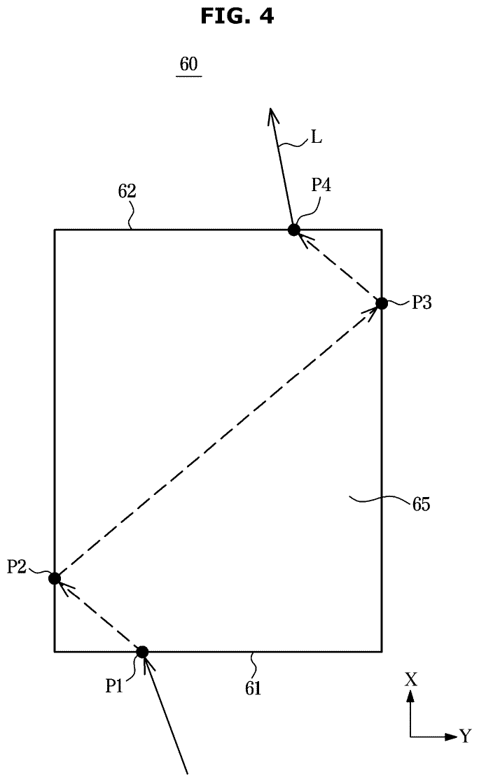

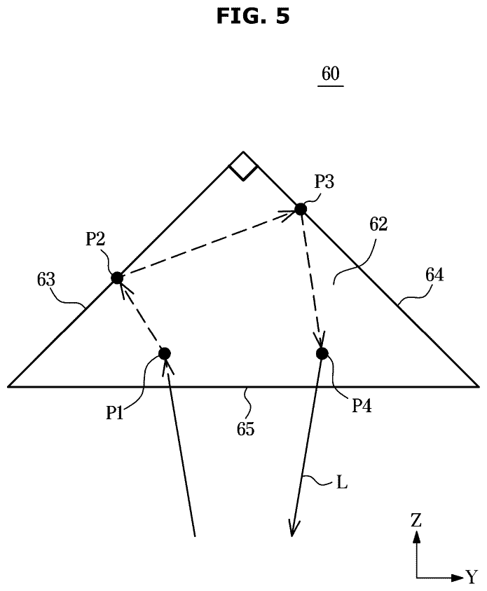

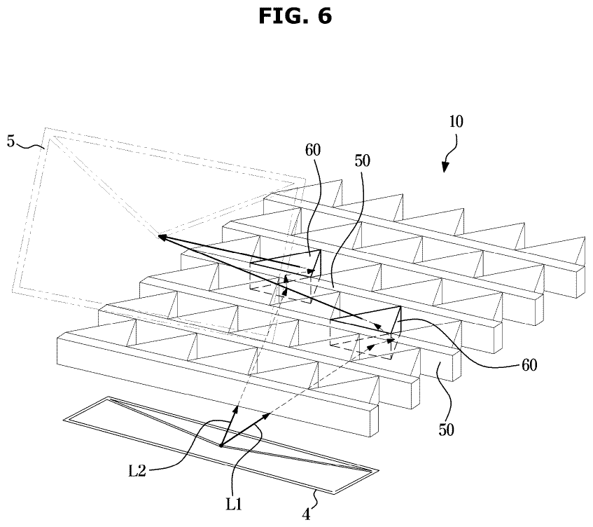

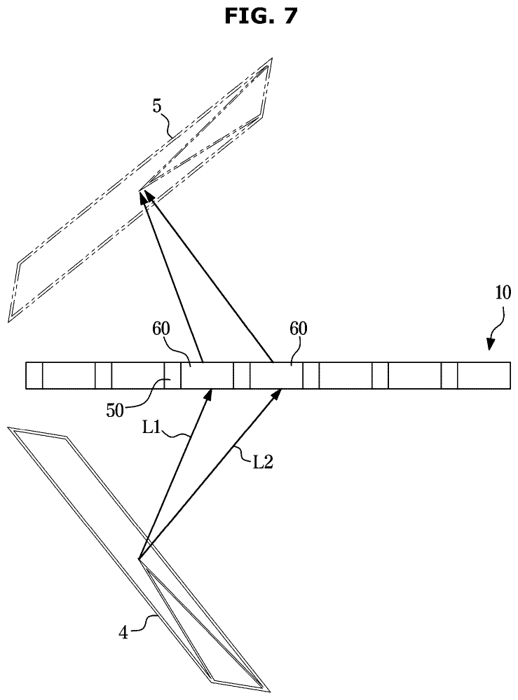

FIG. 2 is an enlarged view of portion ‘O’ of the prism film of FIG. 1, according to an embodiment of the disclosure. FIG. 3 illustrates a prism and a path of light entering the prism, according to an embodiment of the disclosure. FIG. 4 is a side view of the prism of FIG. 3, according to an embodiment of the disclosure. FIG. 5 is a plan view of the prism of FIG. 3, according to an embodiment of the disclosure. FIG. 6 illustrates a path of light entering a prism film, according to an embodiment of the disclosure. FIG. 7 is a side view of the path of light of FIG. 6, according to an embodiment of the disclosure.

Referring to FIG. 2, the prism film 10 may include a plurality of stacked prism strips 40. According to an embodiment, of the prism strips 40 may extend in the direction Y, and the plurality of prism strips 40 may be stacked in the direction Z perpendicular to the direction Y.

Each of the plurality of prism strips 40 may include a substrate layer 50 and a plurality of prisms 60 formed on a first surface 51 of the substrate layer 50. The substrate layer 50 may extend in the direction Y. The plurality of prisms 60 may be arranged in a row in the direction Y. The plurality of prisms 60 may be arranged successively in the direction Y such that neighboring ones of the plurality of prisms 60 adjoin each other. In other words, an edge of one of the plurality of prisms 60 may adjoin an edge of a neighboring prism 60.

According to an embodiment, at least one of the plurality of prisms 60 may have the shape of a triangular prism. For example, the prism 60 may include a first base 61, a second base 62, a first lateral face 63, a second lateral face 64, and a diagonal face 65.

The first base 61 may have the shape of a right-angled triangle. The second base 62 may have a shape corresponding to the first base 61, and may be parallel to the first base 61. The first lateral face 63 may have the shape of a rectangle. The second lateral face 64 may have a shape corresponding to the first lateral face 63. The first lateral face 63 and the second lateral face 64 may adjoin each other and form a right angle. The diagonal face 65 may have the shape of a rectangle, and may connect the first lateral face 63 to the second lateral face 64.

The prism 60 may be formed on the first surface 51 of the substrate layer 50 such that the diagonal face 65 faces the first surface 51 of the substrate layer 50. The prism 60 may be formed on the first surface 51 of the substrate layer 50 such that the diagonal face 65 adjoins the first surface 51 of the substrate layer 50.

An edge between the first lateral face 63 and the second lateral face 64, an edge between the second lateral face 64 and the diagonal face 65, and an edge between the diagonal face 65 and the first lateral face 63 may be parallel to the direction X.

According to an embodiment, the substrate layer 50 and the prism 60 may be formed of a light-transparent material having a higher refractive index than the refractive index of the air. For example, the substrate layer 50 and the prism 60 may be formed of glass or a transparent resin. The transparent material refers to a material that allows transmission of visible light, which may not have a transparency of 100%, and may have a certain color. However, the material of the substrate layer 50 and the prism 60 is not limited thereto.

As shown in FIGS. 3 to 5, light L provided from the image former 3 may enter the prism 60 through the first base 61. For example, the light L provided from the image former 3 may be refracted at a first point P1 on the first base 61 and may enter the prism 60.

The light L entering the prism 60 may be reflected from the first lateral face 63 and the second lateral face 64 in sequence. For example, the light L entering the prism 60 may be reflected at a second point P2 on the first lateral face 63 and then reflected at a third point P3 on the second lateral face 64. According to an embodiment, at the second point P2 and the third point P3, the light may be totally reflected. Therefore, in the prism 60, the light may be totally reflected multiple times.

The light L reflected from the first and second lateral faces 63 and 64 may be emitted from the prism 60 through the second base 62. For example, the light L reflected from the first and second lateral faces 63 and 64 may be refracted at a fourth point P4 on the second base 62 and emitted from the prism 60.

As shown in FIGS. 6 and 7, a plurality of beams (e.g., L1 and L2) provided from the image former 3, entering the prism 60, reflected from the first and second lateral faces 63 and 64 of the prism 60 in sequence and emitted from the prism 60 may be gathered into the floating image 5.

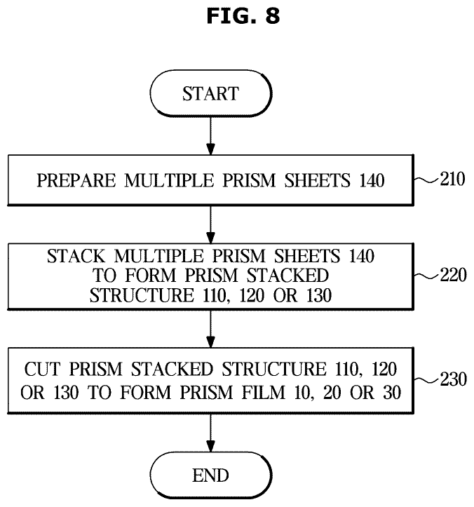

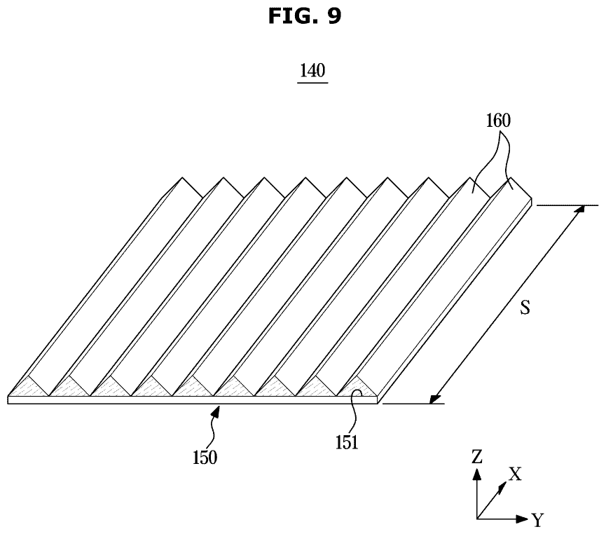

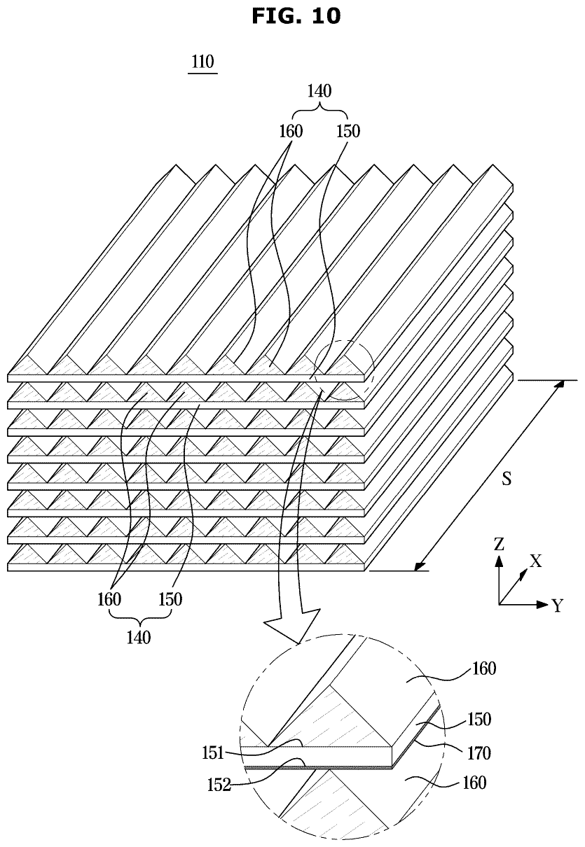

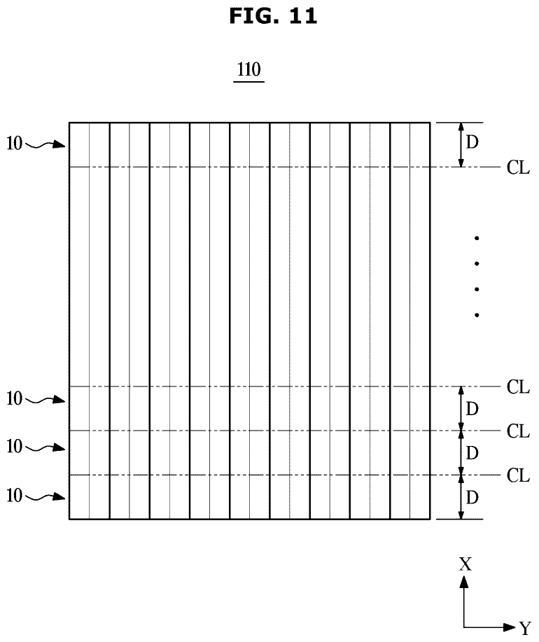

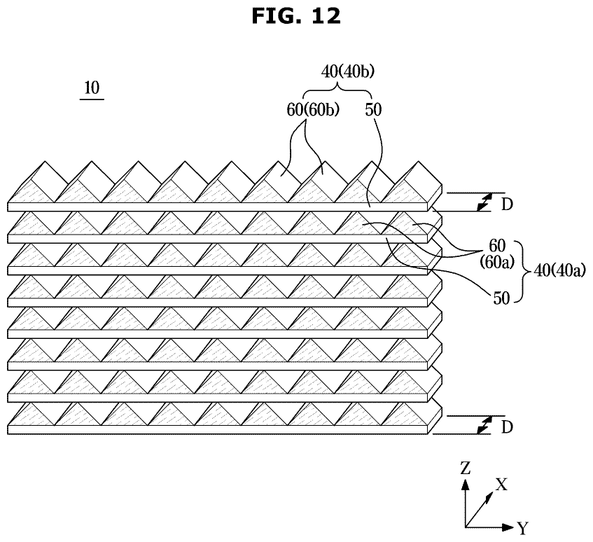

FIG. 8 illustrates a method of manufacturing a prism film for a floating image display apparatus, according to an embodiment of the disclosure. FIG. 9 illustrates a prism sheet, according to an embodiment of the disclosure. FIG. 10 illustrates a prism stacked structure, according to an embodiment of the disclosure. FIG. 11 is a plan view illustrating an operation of cutting the prism stacked structure of FIG. 10, according to an embodiment of the disclosure. FIG. 12 illustrates a prism film formed by the operation of cutting the prism stacked structure of FIG. 11, according to an embodiment of the disclosure.

Referring to FIGS. 8 to 12, a method of manufacturing the prism film 10, 20 or 30 for a floating image display apparatus according to an embodiment of the disclosure will be described.

The method of manufacturing the prism film for floating image display apparatus may include preparing a plurality of prism sheets 140, in 210.

For example, the prism strip 40 illustrated in FIG. 2 may be a segment formed by dividing the prism sheet 140.

The preparing of the plurality of prism sheets 140 may include preparing a substrate layer 150 and forming a plurality of prisms 160 on a first surface 151 of the substrate layer 150.

As shown in FIG. 9, the prism sheet 140 may include the substrate layer 150 and the plurality of prisms 160 formed on the first surface 151 of the substrate layer 150. The substrate layer 150 may be formed as a flat plate extending in the direction X and the direction Y perpendicular to the direction X.

According to an embodiment, the plurality of prisms 160 may be arranged in a row in the direction Y. The plurality of prisms 160 may be arranged successively in the direction Y so that neighboring ones of the plurality of prisms 160 adjoin each other. The plurality of prisms 160 may be formed on the first surface 151 of the substrate layer 150 through a roll imprinting method. How to form the plurality of prisms 160 on the first surface 151 of the substrate layer 150 is not, however the disclosure is not limited thereto. According to an embodiment, the plurality of prisms 160 and the substrate layer 150 may be integrally formed.

At least one of the plurality of prisms 160 may have the shape of a triangular prism. The prism 160 may include a first base, a second base, a first lateral face, a second lateral face and a diagonal face.

According to an embodiment, the first base may have the shape of a right-angled triangle. The second base may have a shape corresponding to the first base, and may be parallel to the first base. The first lateral face may have the shape of a rectangle. The second lateral face may have a shape corresponding to the first lateral face. The first lateral face and the second lateral face may form a right angle. The diagonal face may have the shape of a rectangle, which connects the first lateral face to the second lateral face.

The prism 160 may be formed on the first surface 151 of the substrate layer 150 such that the diagonal face faces the first surface 151 of the substrate layer 150. The prism 160 may be formed on the first surface 151 of the substrate layer 150 such that the diagonal face 165 adjoins the first surface 151 of the substrate layer 150.

The prism sheet 140 may have a length S in the direction X. As the prism 160 formed on the first surface 151 of the substrate layer 150 extends in the direction X, the length S of the prism 160 in the direction X may be equal to the length S of the substrate layer 150 in the X direction.

According to an embodiment, the substrate layer 150 and the prisms 160 may be formed of a light-transparent material having a higher refractive index than the refractive index of the air. For example, the substrate layer 150 and the prism 160 may be formed of glass or a transparent resin. However, the material of the substrate layer 150 and the prism 160 is not limited thereto.

According to an embodiment, the method of manufacturing the prism film for the floating image display apparatus may include stacking a plurality of prism sheets 140 to form a prism stacked structure 110, 120 or 130 (see FIGS. 10, 13 and 15). The plurality of prism sheets 140 may be stacked in the direction Z perpendicular to the directions X and Y.

According to an embodiment, the plurality of prism sheets 140 may each include an adhesive layer 170 formed on a second surface 152 of the substrate layer 150. In other words, the method of manufacturing the prism film for the floating image display apparatus may include forming the adhesive layer 170 on the second surface 152 of the substrate layer 150.

The prisms 160 on one of the plurality of prism sheets 140 may be adhered to the adhesive layer 170 of a neighboring one of the plurality of prism sheets 140 to be stacked on the one prism sheet 140. The adhesive layer 170 may include an adhesive or a cohesionant.

According to an embodiment, the method of manufacturing the prism film for the floating image display apparatus may include cutting the prism stacked structure 110, 120 or 130 to form the prism film 10, 20 or 30, in 230.

As shown in FIG. 11, the prism stacked structure 110, 120 or 130 may be cut along at least one cutting plane CL. The at least one cutting plane CL may extend in the directions Y and Z. In other word, the at least one cutting plane CL may be parallel to a YZ-plane. Segments cut along the at least one cutting plane CL may form the prism film 10, 20 or 30.

By cutting the prism stacked structure 110, 120 or 130 along the at least one cutting plane CL, the plurality of prism films 10, 20 or 30 may be formed.

As described above, each prism film 10, 20 or 30 may include the plurality of prism strips 40 stacked on top of one another in the direction Z. The plurality of prism strips 40 may each include an adhesive layer 170 (see FIG. 10) arranged on the second surface 52 of the substrate layer 50.

The distance D between the cutting planes CL to cut the prism stacked structure 110, 120 or 130 may be constant. As shown in FIG. 12, the distance D between the cutting planes CL may be the length D of the prism film 10, 20 or 30 in the direction X. Furthermore, it may be the length D of the prism 60 arranged on the prism film 10, 20 or 30 in the direction X.

As shown in FIG. 12, according to an embodiment, among a plurality of prism strips 40a and 40b, a first prism strip 40a and a second prism strip 40b that neighbors the first prism strip 40a may be arranged to correspond to each other. In other words, prisms 60a of the first prism strip 40a and prisms 60b of the second prism strip 40b may be arranged to be in corresponding locations in the stacking direction Z.

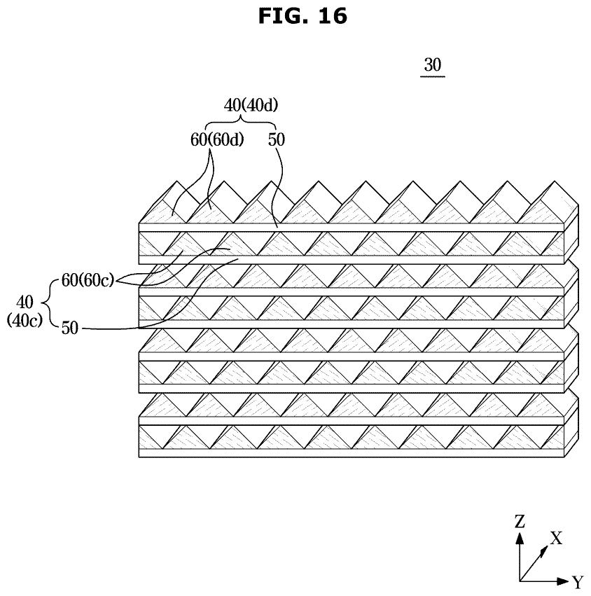

However, the disclosure is not limited thereto. For example, according to an embodiment shown in FIG. 16, among a plurality of prism strips 40c and 40d, a first prism strip 40c and a second prism strip 40d that neighbors on the first prism strip 40c may be arranged to cross each other. For example, with respect to the direction Y, a center of the diagonal face of prims 60c may be offset from a center of the diagonal face of prisms 60d. In other words, prisms 60c of the first prism strip 40c and prisms 60d of the second prism strip 40d may be arranged in zigzags to cross each other in the stacking direction Z of the first and second prism strips 40c and 40d.

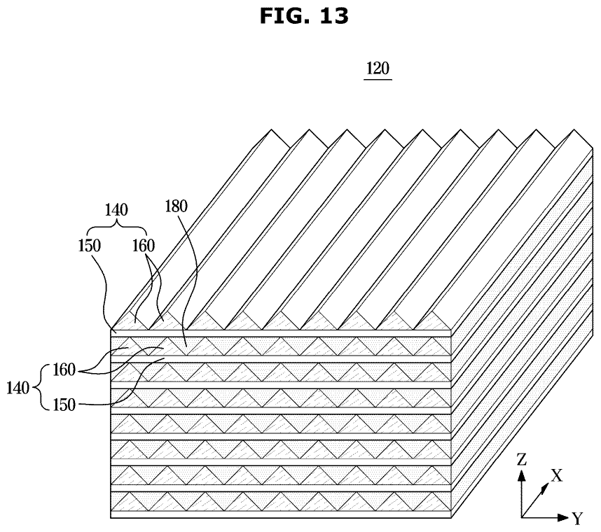

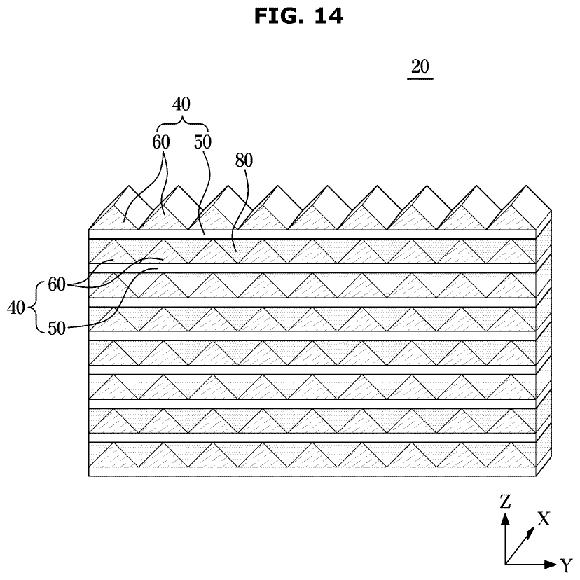

FIG. 13 illustrates a prism stacked structure, according to an embodiment of the disclosure. FIG. 14 illustrates a prism film formed by cutting the prism stacked structure of FIG. 13, according to an embodiment of the disclosure.

Referring to FIGS. 13 to 14, a method of manufacturing the prism film 20 for a floating image display apparatus according to an embodiment of the disclosure will be described.

The method of manufacturing the prism film for the floating image display apparatus described above may be equally applied to the method of manufacturing the prism film 20 for the floating image display apparatus according to an embodiment of FIGS. 13 and 14.

The method of manufacturing the prism film 20 for the floating image display apparatus may further include filling a filler layer 180 between the plurality of prism sheets 140. With the filler layer 180 arranged between the prism sheets 140, structural stability of the prism film 20 may increase and deformation of the shape may be prevented.

The filler layer 180 may include a resin material having a lower refractive index than those of the prisms 160. As the filler layer 180 has a lower refractive index than the prisms 160, total internal reflection of light may occur in the prism 60.

Furthermore, the filler layer 180 may have a black color to absorb beams that do not contribute to forming the floating image 5. For example, the filler layer 180 may include a carbon black, polyene pigment, azo pigment, azomethine pigment, diammonium pigment, phthalocyanine pigment, quinone pigment, indigo pigment, thioindigo pigment, dioxadine pigment, quinacridone pigment, isoindolinone pigment, but the disclosure is not limited thereto.

With the filler layer 180 filled between the plurality of prism sheets 140, the prism stacked structure 120 may include the filler layer 180 filled between the plurality of prism sheets 140. Furthermore, the prism film 20 formed by cutting the prism stacked structure 120 may include the filler layer 80 filled between the plurality of prism strips 40.

The filler layer 80 filled between the plurality of prism strips 40 may be formed of a resin material having a lower refractive index than the prisms 60. The filler layer 80 may have a black color to absorb unnecessary beams that do not contribute to forming the floating image 5.

For example, the filler layer 80 may absorb, among beams provided from the image former 3, beams that do not enter through the first base 61 of the prism 60 or beams that are reflected in the prism 60 an odd number of times. These beams may not form the floating image 5, but rather damage the sharpness of the floating image 5. As the unnecessary beams are absorbed by the filler layer 80, the sharpness of the floating image 5 may be enhanced.

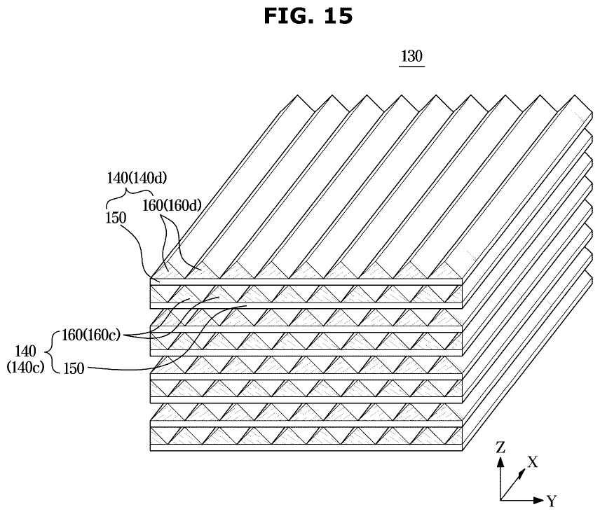

FIG. 15 illustrates a prism stacked structure, according to an embodiment of the disclosure. FIG. 16 illustrates a prism film formed by cutting the prism stacked structure of FIG. 15 according to an embodiment.

As described above, among the plurality of prism strips 40c and 40d, the first prism strip 40c and the second prism strip 40d that neighbors on the first prism strip 40c may be arranged to cross each other. With respect to the direction Y, a center of the diagonal face of prims 60c may be offset from a center of the diagonal face of prisms 60d.

In other words, prisms 60c of the first prism strip 40c and prisms 60d of the second prism strip 40d may be arranged in zigzags to cross each other in the stacking direction Z of the first and second prism strips 40c and 40d.

According to an embodiment of the disclosure, manufacturing of a prism film and floating image display apparatus using the same may be more efficient, and the manufacturing costs may be reduced.

According to an embodiment of the disclosure, a quality of floating images formed by the floating image display apparatus may be improved.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A floating image display apparatus comprising:
a display configured to output light corresponding to an image; and
a prism film configured to reflect the light output by the display to form a floating image,
wherein the prism film comprises a plurality of prism strips stacked in a first direction, and
wherein at least one prism strip among the plurality of prism strips comprises:
a substrate layer extending in a second direction perpendicular to the first direction, and
a plurality of prisms provided along the second direction on a first surface of the substrate layer.

2. The floating image display apparatus of claim 1, wherein at least one prism among the plurality of prisms has a shape of a triangular prism.

3. The floating image display apparatus of claim 2, wherein the at least one prism comprises:
a first base having a shape of a right-angled triangle;
a second base having a shape corresponding to the first base;
a first lateral face having a shape of a rectangle;
a second lateral face having a shape corresponding to the first lateral face and forming a right angle with the first lateral face; and
a diagonal face connecting the first lateral face and the second lateral face.

4. The floating image display apparatus of claim 3, wherein the diagonal face faces the first surface of the substrate layer.

5. The floating image display apparatus of claim 3, wherein the at least one prism is configured to receive the light output by the display through the first base, reflect the light with the first lateral face and the second lateral face in sequence, and emit the light through the second base.

6. The floating image display apparatus of claim 5, wherein the at least one prism is configured to form the floating image based on the light emitted through the second base.

7. The floating image display apparatus of claim 1, wherein the plurality of prisms comprise a light-transparent material having a higher refractive index than air.

8. The floating image display apparatus of claim 1, wherein the plurality of prism strips comprises an adhesive layer on a second surface of the substrate layer, the second surface being opposite to the first surface.

9. The floating image display apparatus of claim 1, wherein the prism film comprises a filler layer between the plurality of prism strips.

10. The floating image display apparatus of claim 9, wherein a refractive index of the filler layer is lower than a refractive index of the plurality of prisms.

11. The floating image display apparatus of claim 9, wherein the filler layer has a black color.

12. The floating image display apparatus of claim 1, wherein, among the plurality of prism strips, a first prism strip and a second prism strip stacked on the first prism strip are arranged to correspond along the second direction.

13. The floating image display apparatus of claim 1, wherein, among the plurality of prism strips, a first prism strip and a second prism strip stacked on the first prism strip are arranged to be offset along the second direction.

14. A method of manufacturing a prism film for a floating image display apparatus, the method comprising:
preparing a plurality of prism sheets, each of the plurality of prism sheets including a plurality of prisms arranged in a first direction;
stacking the plurality of prism sheets in a second direction perpendicular to the first direction to form a stacked prism structure; and
cutting the stacked prism structure along a cutting plane.
